(19) United States
(12) Patent Application Publication
(10) Pub. No.: US 2013/0146540 A1
(43) Pub. Date: Jun. 13, 2013

(54) SYSTEM AND PROCESS FOR TREATING WATER AND SPIRAL WOUND MEMBRANE ELEMENT

(71) Applicants: Prasanna Rao DONTULA, Bangalore (IN); Yatin TAYALIA, Singapore (SG); Upen Jayant BHARWADA, Scottsdale, AZ (US)

(72) Inventors: Prasanna Rao DONTULA, Bangalore (IN); Yatin TAYALIA, Singapore (SG); Upen Jayant BHARWADA, Scottsdale, AZ (US)

(73) Assignee: GENERAL ELECTRIC COMPANY, Schenectady, NY (US)

(21) Appl. No.: 13/315,731

(22) Filed: Dec. 9, 2011

(51) Int. Cl. C02F 1/44; B01D 63/12; B01D 61/02; B01D 65/00

(52) U.S. Cl. 210/652; 210/541; 210/321.83; 210/650

(57) ABSTRACT

A spiral would membrane element has a feed channel spacer providing a tortuous feed flow path through an open spacer mesh material. The feed flow path may force the feed liquid to flow across substantially all of an adjacent membrane surface. The length of the flow path and average cross-flow velocity are increased relative to a straight flow path. A rise in pressure drop that might otherwise be produced by the increased average cross-flow velocity is reduced by the open spacer mesh. In a system having two or more upstream and downstream spiral wound membrane elements, a downstream element may have a feed channel spacer providing a tortuous flow path while an upstream element has a feed channel spacer providing a less tortuous flow path or a straight flow path.

### FIELD

The present disclosure relates to spiral wound membrane elements and to systems and processes for treating water using spiral wound membrane elements.

### BACKGROUND

The following description of the background of the invention is not an admission that anything discussed below is common general knowledge.

A spiral wound membrane element is manufactured by rolling one or more envelopes, each comprising two membrane sheets enclosing a permeate spacer, around a perforated central tube. Adjacent membrane sheets are separated by a feed channel spacer, which may also be called a brine spacer. The element is enclosed for use in a tubular pressure vessel. Feed flows into one end of the pressure vessel and through the feed channel spacer of the element. A portion of the feed flows through the membrane sheets, through the permeate spacer, and into the perforated central tube to be discharged as permeate from an open end of the central tube. The remainder of the feed exits the feed channel as concentrate and is removed from the other end of the pressure vessel. Multiple elements may be connected end to end in a shared pressure vessel with appropriate conduits or seals connecting the feed/concentrate and permeate sides of the elements in series.

The general requirements of a high performance spiral wound membrane element include high permeate flow and high solute rejection with low fouling tendencies. Permeate flow and solute rejection may be limited by concentration polarization (CP) on the feed side of the membrane sheets. In general terms, concentration polarization occurs as the permeate passes through the membrane leaving a solute in the feed liquid concentrated in a thin layer adjacent the membrane. The CP layer creates a resistance to permeate flow. One of the functions of the feed channel spacer is to generate sufficient mixing in the feed flowing adjacent to the membrane to reduce the effect of concentration polarization.

U.S. Pat. No. 4,814,079 to Schneider discloses a spiral wound reverse osmosis (RO), ultrafiltration (UF) or microfiltration (MF) element having an open channel directed feed flow path. The flow of feed across the surface of the membrane is controlled by a feed separator which may comprise a plurality of substantially parallel separator strips of impermeable material. The open channel may include a short length of a mesh or grid strips at specified locations. The flow path provides a non-interrupted meandering path across the length and width of the surface of the membrane. Portions of an upstream and downstream edge of the feed separator are filled with mesh rather than separator strips to provide an inlet and outlet to the feed separator.

US 2004/0182774 to Hirokawa et al. discloses a spiral separation membrane element having feed side materials having warps almost parallel to the direction of flow, and wefts, thinner than the warps, at a prescribed pitch designed to reduce the pressure drop on the feed side as well as reduce clogging of the feed channel.

US 2004/0222158 to Husain et al. discloses a nanofiltration (NF) system for water softening. A spiral wound filtration module is operated with a single pass through the feed side without cross-flow on the permeate side. The module may have dams in the spacer material on the shell/feed side to provide a path with multiple passes across the membrane leaves. The passes may have a declining width to provide a generally constant or increasing feed side velocity in the direction of feed flow. For example, an outlet in a downstream edge of the feed spacer may have a width and a cross-sectional area of 20% or less of an inlet in a part of the upstream edge of the feed spacer.

Ahmad and Lau, in “Impact of different spacer filaments geometries on 2D unsteady hydrodynamics and concentration polarization in spiral wound membrane channel”, Journal of Membrane Science 286 (2006) 77-92, use computational fluid dynamics to demonstrate that a mesh spacer with strands of circular cross-section is more efficient at reducing the effect of concentration polarization than a mesh spacer with strands of rectangular cross-section.

US 2007/0175812 to Chikura et al. discloses a spiral separation membrane element with feed-side channel components being a net formed by fusion bonding.

Lau et al., in “Feed spacer mesh angle: 3D modeling, simulation, and optimization based on unsteady hydrodynamic in spiral wound membrane channel”, Journal of Membrane Science 343 (2009) 16-33, use computational fluid dynamics to demonstrate an optimal included angle between the strands in a mesh-type spacer to reduce the effect of concentration polarization.

One application for spiral wound membranes is in sea water desalination to provide fresh water. In this application, the membrane sheets are typically reverse osmosis (RO) membranes, and the process may be referred to as seawater reverse osmosis (SWRO). In SWRO applications, the amount of permeate recovered from each element is low and so the feed water passes through a series of elements in order to improve the overall recovery rate of the system. For example, in a “Christmas tree” design, feed passes through an upstream stage having the two or more pressure vessels in parallel. Permeate is removed from the upstream stage but the feed/concentrate is passed on to one or more downstream stages. Since permeate is drawn off at each stage, downstream stages are adapted for lower feed flow rates by having fewer, or only one, pressure vessel. In a “multi-stage recirculation” design, feed passes through two or more stages, with recirculation of a portion of the concentrate from an upstream stage to the feed of a downstream stage in order to increase the feed velocity in the downstream stage.

### BRIEF DESCRIPTION OF THE INVENTION

A feed channel spacer for a spiral wound membrane element is described in this specification. The feed channel spacer has one or more baffles or obstructions to define a feed flow path. The flow path may be tortuous, with the feed directed to flow back and forth across the surface of the membrane. The feed liquid may be forced to flow across areas of the membrane that might otherwise not participate equally in the separation process.

The width of at least a portion of the flow path is less than the width of a typical straight flow path spanning the entire width of the feed spacer. The length of the flow path is longer than the length of the feed spacer. Accordingly, the average cross-flow velocity of the feed is increased relative to the same amount of flow passing through a conventional homogenous feed spacer having a flow path equal in width and length to the outer dimensions of the feed spacer. The higher average velocity may tend to reduce the thickness of the CP layer, and lower the resistance to permeate flow caused by the CP layer, under some operating conditions. Consequently, the net driving pressure (NDP) for flow through the membrane may be increased, resulting in increased flux and element recovery under some operating conditions.

A rise in pressure drop that might otherwise be produced by the increased average cross-flow velocity is reduced by using an open spacer mesh in the flow path. For example, the pitch of a mesh within the flow path may be increased relative to typical feed channel spacers. The increased pitch may compensate, at least in part, for an increase in pressure drop that might otherwise result from a tortuous feed path. The baffle may be made of a second layer of feed spacer material.

In a pressure vessel containing two or more spiral wound membrane elements, a downstream spiral wound membrane element has a feed channel spacer that provides a longer flow path compared to the flow path of an upstream element. For example, a downstream element may have a feed channel spacer providing a tortuous flow path while an upstream element has a feed channel spacer providing a less tortuous flow path or a straight flow path. The elements may be used to provide a seawater reverse osmosis (SWRO) or other desalination process in a single stage.

### BRIEF DESCRIPTION OF THE DRAWINGS

FIG. 1 shows a feed spacer.

FIG. 2 shows a system for water treatment.

FIG. 3 shows a schematic of a feed/concentrate side of the system of FIG. 2.

FIG. 4 shows another system for water treatment.

FIG. 5 shows a schematic of a feed/concentrate side of the system of FIG. 4.

FIG. 6 shows a representative graph indicating pressure drop per unit length compared to average flow velocity.

FIG. 7 shows another feed spacer.

### DETAILED DESCRIPTION

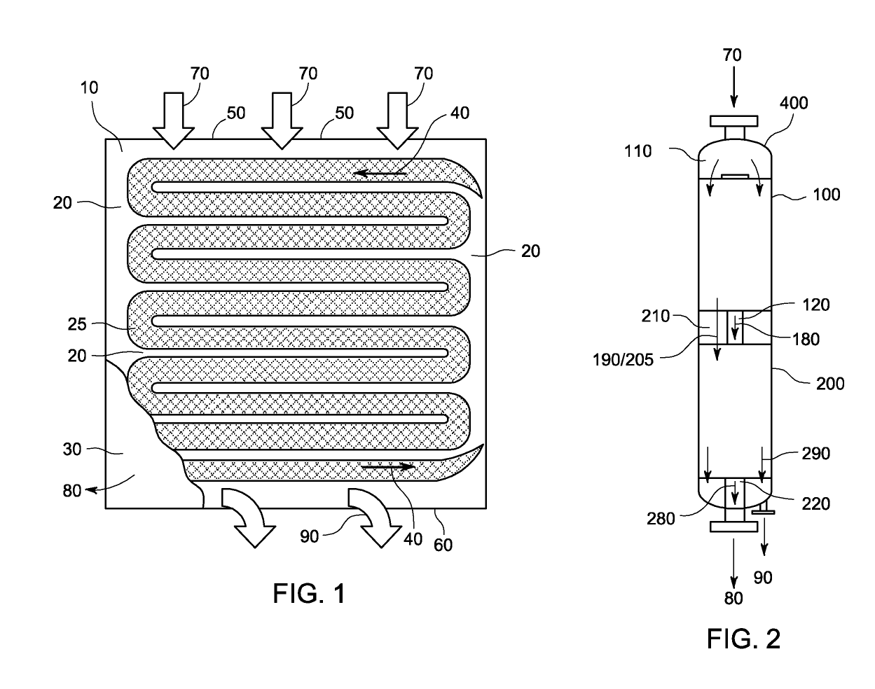

Referring to FIG. 1, a feed channel spacer 10 includes one or more baffles 20 defining a flow passage 40 applied on to a first sheet of feed spacer material 25, typically a mesh or net of thermoplastic fibers. The baffles 20 may be made from an additional layer of feed spacer material compressed into the first layer of feed spacer material 25. The additional layer of feed spacer material may also be bonded, for example by an adhesive or by melting or by sonic welding, in some locations with the first layer of feed spacer material 25. The compression is preferably done in combination with heating such that the two layers of feed spacer material 20, 25 are above their heat deflection temperature. In this way, the parts of the feed channel spacer 10 with baffles 20 are not substantially thicker than the rest of the feed channel spacer 10. Despite the compression, the baffles 20 permit some flow through them but with increased resistance relative to the rest of the feed channel spacer. A primary flow passage 40 extends through the first layer of feed spacer material 25 between an inlet 50 and an outlet 60. At the inlet 50 and outlet 60, the increased resistance provided by the baffles 20 helps distribute flow across the entire width of the inlet 50 and outlet 60. However, between the inlet 50 and the outlet 60, water tends to follow a flow path 40 around the baffles 20 in a serpentine path. A liquid feed 70 flows from the inlet 50, through the flow path 40, across the surface of a membrane 30 that will be located adjacent to the feed channel spacer 10 in a spiral wound membrane element. Permeate 80 passes through the membrane 30 (shown in partial cut-away). Feed water than does not permeate through the membrane 30 exists form the feed channel spacer 10 as concentrate 90 from the outlet 60. The arrows indicate the inlet and outlet directions of the liquid flow. When the feed channel spacer 10 shown in FIG. 1 is installed in a membrane element, the lefts side edge of the feed channel spacer 10 is inserted into a fold or seal connecting two membrane 30 sheets adjacent to a permeate collection tube. The right side edge of the feed channel spacer 10 is contained between overlapping membranes sheets 30 above and below the feed channel spacer 10 or by an outer wrap of the element.

The baffles 20 reduce the available flow area and therefore increase the average cross-flow velocity of the liquid feed 70 relative to a feed spacer without baffles 20. In addition, the baffles 20 control the flow of the liquid feed 70 so that the liquid feed 70 is directed to flow over substantially all of the area of the membrane 30. The forced flow of feed 70 reduces the tendency of parts of the membrane 30 to foul more rapidly than others because they might otherwise be located in areas of stagnant feed flow. A reduction in fouling prone areas may allow for fewer cleaning cycles and increased life of the membrane 30.

Referring to FIG. 7 a second feed channel spacer 10 is shown with one internal baffle 20a creating a flow path 40 having two legs, 40a and 40b. The feed channel spacer 10 of FIG. 1 had 9 internal baffles 20 creating a flow path 40 having 10 legs. Other feed channel spacers may be made with other numbers of internal baffles and flow path legs between the examples of FIG. 1 and FIG. 7.

The baffles 20 and the mesh 25 of the spacer are preferably designed to maintain the same pressure drop across the ends of the spiral element even at the higher cross flow velocities that are produced as a consequence of longer liquid flow path length, or at last to reduce the increase in pressure drop. In particular, the mesh 25 is made more open, with less filaments per unit distance, as the number of internal baffles 20 increases.

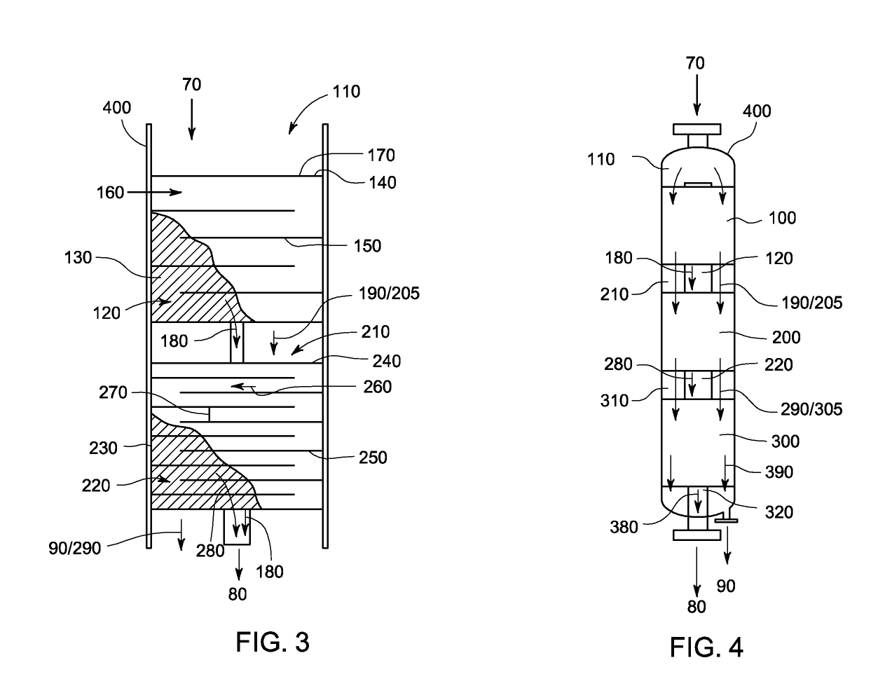

Referring to FIG. 2 and FIG. 3, an upstream spiral wound membrane element 100 and a downstream spiral wound membrane element 200 are housed within a housing 400.

The upstream spiral wound membrane element 100 has an upstream feed/concentrate side 110 and an upstream permeate side 120 separated by an upstream membrane 130 (see FIG. 3, shown in partial cut-away). The upstream feed/concentrate side 110 includes an upstream feed channel spacer 140 (FIG. 3). One or more upstream baffles 150 define an upstream flow passage 160 across the upstream membrane 130. The upstream flow passage 160 has an upstream flow passage area 170.

The downstream spiral wound membrane element 200 has a downstream feed/concentrate side 210 and an downstream permeate side 220 separated by an downstream membrane 230 (see FIG. 3, shown in partial cut-away). The downstream feed/concentrate side 210 includes an downstream feed channel spacer 240. One or more downstream baffles 250 define a downstream flow passage 260 across the downstream membrane 230. The downstream flow passage 260 has a downstream flow passage area 270.

The upstream feed/concentrate side 110 and the downstream feed/concentrate side 210 are in fluid communication. The upstream permeate side 120 and the downstream permeate side 220 are in fluid communication.

The downstream flow passage area 270 is less than or equal to the upstream flow passage area 170.

The feed channel spacer (e.g. the upstream feed channel spacer 140 or the downstream feed channel spacer 240 or both) and the baffles (e.g. the upstream baffle 150 or the downstream baffle 250 or both) may be designed to maintain a pressure drop across the spiral wound membrane element about the same as the pressure drop of a mesh screen spacer. However, the velocity of the liquid feed 70 across the membrane (e.g. upstream membrane 130 or downstream membrane 230 or both) is higher. At least under operating conditions wherein the average velocity of the feed flow would not produce significant turbulence in a feed spacer with a conventional straight flow path, the increased average feed velocity through a tortuous flow path may reducing the thickness of the CP layer.

In operation, a liquid feed 70 flows through the upstream feed/concentrate side 110. A portion of the liquid feed 70 passes through the upstream membrane 130 to the upstream permeate side 120 and is collected as upstream permeate 180. The remainder of the liquid feed 70 exits the upstream feed/concentrate side 110 as upstream concentrate 190. The upstream concentrate 190 becomes downstream liquid feed 205 and flows through the downstream feed/concentrate side 210. A portion of the downstream liquid feed 205 passes through the downstream membrane 230 to the downstream permeate side 220 and is collected as downstream permeate 280. The remainder of the downstream liquid feed 205 exits the downstream feed/concentrate side 210 as downstream concentrate 290, and exits the housing 400 as concentrate 90.

By reducing the flow passage area (e.g. the upstream flow passage area 170 or the downstream flow passage area 270 or both), the velocity of the liquid across the membrane (e.g. the upstream membrane 130 or the downstream membrane 230 or both) is selected to be sufficient to reduce the CP layer thickness. In addition, the flow passage (e.g. the upstream flow passage 160 or the downstream flow passage 260 or both) directs the feed across the respective membrane.

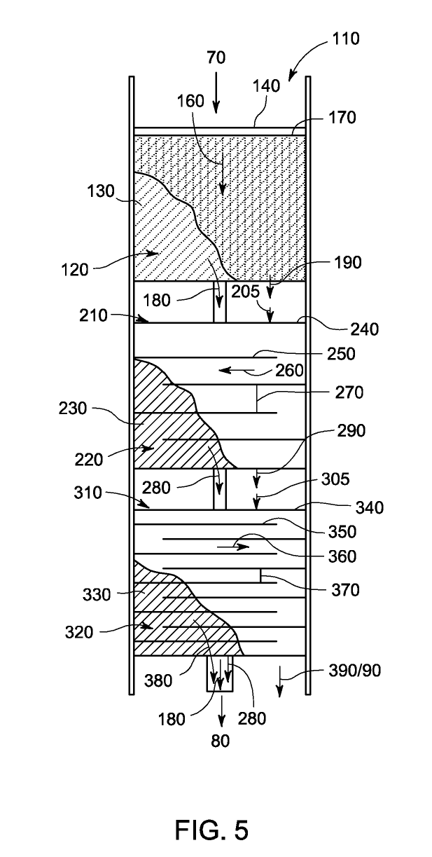

Referring to FIGS. 4 and 5, an upstream spiral wound membrane element 100, a downstream spiral wound membrane element 200, and a tertiary spiral wound membrane element 300 are mounted in housing 400.

The upstream spiral wound membrane element 100 has an upstream feed/concentrate side 110 and an upstream permeate side 120 separated by an upstream membrane 130 (see FIG. 5, shown in partial cut-away). The upstream feed/concentrate side 110 includes an upstream feed channel spacer 140 defining an upstream flow passage 160. The upstream flow passage 160 has an upstream flow passage area 170. The upstream feed channel spacer 140 shown is a conventional mesh screen type feed channel spacer.

The downstream spiral wound membrane element 200 has a downstream feed/concentrate side 210 and an downstream permeate side 220 separated by a downstream membrane 230 (see FIG. 5, shown in partial cut-away). The downstream feed/concentrate side 210 includes an downstream feed channel spacer 240. One or more downstream baffles 250 define a downstream flow passage 260 across the downstream membrane 230. The downstream flow passage 260 has a downstream flow passage area 270.

The tertiary spiral wound membrane element 300 has a tertiary feed/concentrate side 310 and a tertiary permeate side 320 separated by an tertiary membrane 330 (see FIG. 5, shown in partial cut-away). The tertiary feed/concentrate side 310 includes a tertiary feed channel spacer 340. One or more tertiary baffles 350 define a tertiary flow passage 360 across the tertiary membrane 330. The tertiary flow passage 360 has a tertiary flow passage area 370.

The upstream feed/concentrate side 110, the downstream feed/concentrate side 210, and the tertiary feed/concentrate side 310 are in fluid communication. The upstream permeate side 120, the downstream permeate side 220, and the tertiary permeate side 230 are in fluid communication.

In operation, a liquid feed 70 flows through the upstream feed/concentrate side 110. A portion of the liquid feed 70 passes through the upstream membrane 130 to the upstream permeate side 120 and is collected as upstream permeate 180. The remainder of the liquid feed 70 exits the upstream feed/concentrate side 110 as upstream concentrate 190. The upstream concentrate 190 becomes downstream liquid feed 205 and flows through the downstream feed/concentrate side 210. A portion of the downstream liquid feed 205 passes through the downstream membrane 230 to the downstream permeate side 220 and is collected as downstream permeate 280. The remainder of the downstream liquid feed 205 exits the downstream feed/concentrate side 210 as downstream concentrate 290. The downstream concentrate 290 becomes tertiary liquid feed 305 and flows through the tertiary feed/concentrate side 310. A portion of the tertiary liquid feed 305 passes through the tertiary membrane 330 to the tertiary permeate side 320 and is collected as tertiary permeate 380. The remainder of the tertiary liquid feed 305 exits the tertiary feed/concentrate side 310 as tertiary concentrate 390, and exits the housing 400 as concentrate 90.

By reducing the flow passage area (e.g. the upstream flow passage area 170 or the downstream flow passage area 270 or the tertiary flow passage area 370 or combinations or all thereof), the velocity of the liquid across the membrane (e.g. the upstream membrane 130 or the downstream membrane 230 or the tertiary membrane 330 or combinations or all thereof) is selected to be sufficient to reduce the CP layer thickness. In addition, the flow passage (e.g. the upstream flow passage 160 or the downstream flow passage 260 or the tertiary flow passage 360 or combinations or all thereof) direct the feed across the respective membrane.

The flow passage areas 170, 270, 370 of the flow passages 160, 260, 360 may progressively decrease per spiral wound membrane element.

In normal practice, as liquid feed passes through a pressure vessel containing multiple spiral wound elements, each subsequent element is exposed to a feed of higher concentration than the element before it. Further, as product or permeate is produced, each downstream element receives less feed than the element before it. These two consequences of standard pressure vessel design and operation, the feed becoming higher in concentration and lesser in volume, tend to magnify the adverse effect of concentration polarization (CP) in downstream elements of a pressure vessel or housing.

In the process and systems disclosed herein, the spiral wound elements within a single pressure vessel may be configured to reduce the flow passage areas 170, 270, 370 as permeate 180 and 280 exit the feed. As a non-limiting example, in a housing 400 having three or more spiral wound membrane filter elements, the last one or two may be operated at a higher average cross-flow velocity, relative to a conventional designs, leading to higher recovery of permeate from the housing 400. The pitch of a spacer mesh in one or more of the downstream elements is higher than the pitch of an upstream element.

Higher permeate flows per element at the same or higher solute rejections may allow for more compact water purification plants with a lower capital expenditure. For example in a sea water reverse osmosis (SWRO) plants, application of the system and process disclosed herein may reduce, or even eliminate, the need for a second stage. In some cases the second stage of a SWRO plant is designed to operate at higher average cross-flow velocities by recycling part of the concentrate stream. In the application and process described herein, a higher average cross flow velocity can be achieved in a downstream element within a single housing. With effective pre-treatment of the feed water, for example to remove suspended or dissolved solids or hardness, a larger number of elements, with longer flow paths in the furthest downstream element, may be possible.

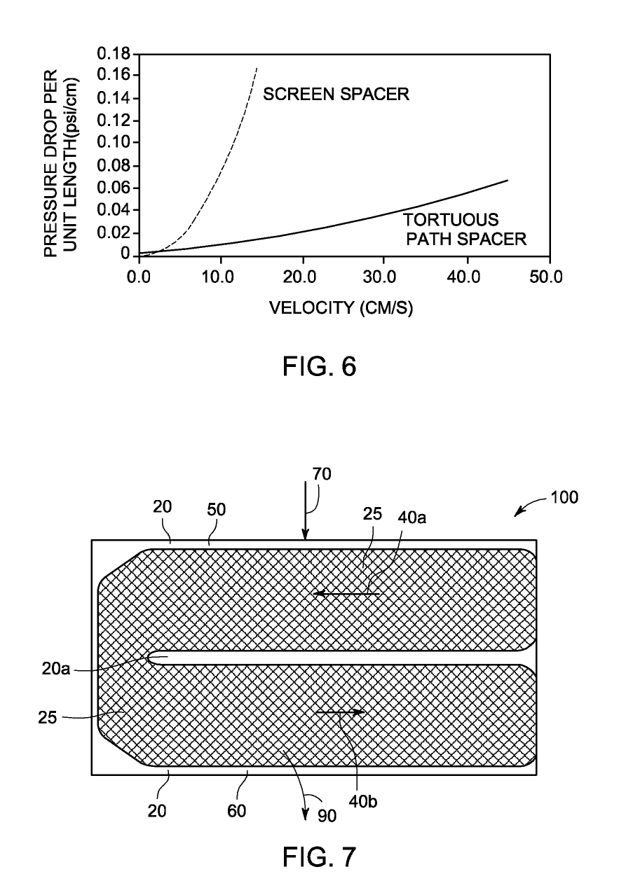

Referring to FIG. 6, the pressure drop per unit length for a given average velocity is shown for a typical commercial screen spacer and for a more open mesh 25 as shown in FIGS. 1 and 7. As shown, the pressure drop per unit length rises more rapidly with velocity in a conventional screen spacer than for the mesh 25. As one non-limiting example, if a typical 40 inch (101.6 cm) long spiral wound membrane element is allowed to have a pressure drop of 0.3 bar (4.35 psi), approximately 0.04 psi/cm, FIG. 6 suggests a conventional screen spacer must have a velocity under 10 cm/s whereas a mesh 25 as disclosed herein could be designed for a velocity over 20 cm/s and a flow path twice as long without a material increase in total pressure drop. The distance between adjacent filament intersections in the mesh 25 may be 3 mm or more, 4 mm or more or 5 mm or more.

This written description uses examples to disclose embodiments of the invention, including the best mode, and also to enable any person skilled in the art to practice embodiments of the invention, including making and using any devices or systems and performing any incorporated methods. The patentable scope of embodiments of the invention is defined by the claims, and may include other examples that occur to those skilled in the art.

What is claimed is:

1. A feed spacer for a spiral wound membrane element comprising,
a) one or more baffles defining a feed flow path through the feed spacer; and,
b) a mesh within the feed flow path, wherein a) the mesh has a spacing between adjacent filament intersections of 3 mm or more or b) the baffle comprises a second layer of feed spacer material.

2. The feed spacer of claim 1 wherein the feed flow path is longer than an overall length of the feed spacer and at least a portion of the feed flow path is narrower than an overall width of the feed spacer.

3. The feed spacer of claim 2 wherein the baffle comprises a second layer of feed spacer material and an inlet to the feed flow path is provided across substantially all of an upstream edge of the feed spacer through a baffle.

4. The feed spacer of claim 1 wherein the feed flow path travels back and forth at least once across the overall length or width of the feed spacer.

5. A liquid treatment system adapted to receive a liquid feed and provide concentrate and permeate, comprising:
an upstream spiral wound membrane element having an upstream feed/concentrate side and an upstream permeate side separated by an upstream membrane, the upstream feed/concentrate side comprising an upstream feed channel spacer defining an upstream flow passage across the upstream membrane, the upstream flow passage having an upstream flow passage area;
a downstream spiral wound membrane element having a downstream feed/concentrate side and a downstream permeate side separated by a downstream membrane, the downstream feed/concentrate side comprising a downstream feed channel spacer comprising one or more downstream baffles defining a downstream flow passage across the downstream membrane, the downstream flow passage having a downstream flow passage area, the average downstream flow passage area being less than the average upstream flow passage area; and
a housing for housing the upstream spiral wound membrane element and the downstream spiral wound element, such that the upstream feed/concentrate side and the downstream feed/concentrate side are in fluid communication, and the upstream permeate side and the downstream permeate side are in fluid communication.

6. The liquid treatment system of claim 5 wherein the upstream feed channel spacer further comprises one or more baffles defining an upstream flow passage across the upstream membrane.

7. The liquid treatment system of claim 5 wherein the one or more downstream baffles define the downstream flow passage as a serpentine flow passage.

8. The liquid treatment system of claim 6, wherein the one or more upstream baffles define the upstream flow passage as a serpentine flow path.

9. The liquid treatment system of claim 1, wherein the downstream flow passage traverses substantially the full area of the downstream membrane.

10. The liquid treatment system of claim 5 wherein a spacer mesh in the upstream element has a lower pitch than a spacer mesh in the downstream element.

11. A liquid treatment process comprising:
providing an upstream spiral wound element having a feed/concentrate side and a permeate side separated by an upstream membrane, the feed/concentrate side comprising an upstream feed channel spacer defining an upstream flow passage across the upstream membrane, the upstream flow passage having an upstream flow passage area;
providing a downstream spiral wound element having a feed/concentrate side and a permeate side separated by a downstream membrane, the feed/concentrate side comprising a feed channel spacer comprising baffles defining a downstream flow passage across the downstream membrane, the downstream flow passage having a downstream flow passage area;
flowing pressurized liquid feed through the feed/concentrate side of the upstream spiral wound element and through the feed/concentrate side of the downstream spiral wound element in series;
collecting a portion of the feed as upstream permeate from the permeate side of the upstream spiral wound element and the downstream permeate side of the downstream spiral wound element,
wherein the downstream flow passage area is less than the upstream flow passage area.

12. The liquid treatment process of claim 11, further comprising pre-treatment of the feed to remove at least a portion of suspended solids in the feed.

13. The liquid treatment process of claim 11 wherein the membranes are a reverse osmosis (RO) membranes.

14. The liquid treatment process of claim 13 wherein the liquid feed is sea water.

15. The liquid purification process of claim 14 wherein feed concentrate is collected at an outlet of the downstream element at a salinity that is acceptable for drinking.
